(19) United States
(12) Patent Application Publication
(10) Pub. No.: US 2025/0341232 A1
(43) Pub. Date: Nov. 6, 2025

(54) BEARING DEVICE WITH INTEGRATED ELECTRICAL INSULATION, NOTABLY FOR AN ELECTRIC MOTOR OR MACHINE, AND ASSOCIATED MANUFACTURING METHODS

(71) Applicant: AKTIEBOLAGET SKF, GOTEBORG (SE)

(72) Inventors: Benoit ARNAULT, Saint-Cyr-sur-Loire (FR); Mickael CHOLLET, Joué-Lès-Tours (FR); Anthony SIMONIN, Tours (FR)

(21) Appl. No.: 19/192,945

(22) Filed: Apr. 29, 2025

(30) Foreign Application Priority Data
May 6, 2024 (FR) 2404704

(51) Int. Cl. F16C 27/06; F16C 19/06; F16C 27/04; F16C 33/58; H02K 5/16

(52) U.S. Cl. CPC F16C 27/066; F16C 19/06; F16C 27/04; F16C 33/583; H02K 5/16; F16C 2202/32; F16C 2208/10; F16C 2380/26

(57) ABSTRACT

A bearing device includes a bearing having first and second mutually rotatable rings, the second ring having a first cylindrical surface and a second cylindrical surface radially spaced from the first cylindrical surface, and a bushing having an axial length and a first cylindrical surface and a second cylindrical surface radially spaced from the first cylindrical surface of the bushing. An elastically deformable member is located radially between the second ring and the bushing, and an electrically insulating insert is overmolded between and connects the first cylindrical surface of the bushing and the second cylindrical surface of the second ring and contacts the elastically deformable member. The elastically deformable member radially contacts the second ring and/or the bushing and is radially compressed relative to a free state of the elastically deformable member.

### CROSS-REFERENCE

This application claims priority to French patent application no. 2404704 filed on May 6, 2024, the contents of which are fully incorporated herein by reference.

### TECHNOLOGICAL FIELD

The present disclosure is directed to the field of bearings that are used in particular in electric motors, electric machines and associated apparatuses.

### BACKGROUND

In an electric motor or machine, at least one rolling bearing is mounted between the housing of the electric motor or machine and the rotary shaft in order to support this shaft. During operation, when the shaft is rotating, a difference in electrical potential can arise between the shaft and the housing of the electric motor or machine, thereby generating an electric current between the inner ring of the rolling bearing, which is rigidly connected to the shaft, and the outer ring, which is rigidly connected to the housing.

The electric current flowing through the components of the rolling bearing can damage these components, notably the rolling elements and raceways provided on the inner and outer rings. Electrical discharges can also generate vibrations. To overcome these drawbacks, it is known practice to replace the rolling elements of the bearing, which are made of the same steel as the inner and outer rings, with rolling elements made from ceramic. This is generally referred to as a hybrid rolling bearing. However, such a hybrid rolling bearing is relatively expensive.

In order to overcome the aforementioned drawbacks, it is also known practice to equip the outer ring of the rolling bearing with an insulating sleeve provided with a bushing and with an insulating insert made of an electrically insulating material and positioned radially between the outer ring and the bushing. In order to attach the insulating insert to the outer ring and to the bushing without any additional elements or specific machining on the outer ring, the insulating insert can be overmolded. However, with such a solution, relative uncoupling of the insulating insert and the bushing can occur during operation.

### SUMMARY

An aspect of the present disclosure is therefore to overcome the aforementioned drawbacks by providing a bearing device which has a simple and economical design.

An embodiment of the invention is a bearing device comprising a bearing having a first ring and a second ring configured rotate relative to one another. The device further comprises at least one insulating sleeve mounted on the second ring of the bearing. The insulating sleeve has a bushing and an electrically insulating insert positioned radially between the second ring of the bearing and the bushing. The insulating insert is made of electrically insulating material. The bushing comprises an outer surface and an inner surface, opposite the outer surface, which delimit the radial thickness of the bushing.

The second ring comprises an outer surface and an inner surface opposite to the outer surface, which delimit the radial thickness of the second ring. The insulating insert is overmolded at least on one of the outer and inner surfaces of the second ring of the bearing and at least on one of the outer and inner surfaces of the bushing.

According to an overall feature, the device also comprises at least one elastically deformable member which is located radially between the second ring and the bushing and is partially covered by the insulating insert. An “elastically deformable member” is understood to mean a component which is capable, on account of the material used and/or its dimensioning, of deforming under the action of an external stress and tending to return to its initial shape by elasticity if the stress stops being applied.

A “member radially between the second ring and the bushing” is understood to mean a member which is located between the second ring and the bushing considering the radial direction, irrespective of whether there is another element radially between the member and the second ring or radially between the member and the bushing, for example the insulating insert, or not.

According to another overall feature, the elastic member is radially in contact at least with one of the surface of the second ring and the surface of the bushing by being compressed in the radial direction. This provides a bearing device that has integrated electrical insulation and is economical in relation to conventional hybrid rolling bearings. Furthermore, the device is easy to manufacture and assemble in the associated electric motor or machine.

Furthermore, the provision of the elastically deformable member makes it possible to obtain a good rigid connection in the circumferential direction between the insulating insert and the bushing and/or the second ring, thereby limiting the risk of relative movements notably during variations in temperature.

Specifically, given its radial compression, the elastically deformable member tends to return to its non-deformed initial shape, thereby making it possible to increase the friction with the insulating insert and the second ring of the bearing and/or the bushing. In its mounted position, the radial dimension of the elastically deformable member is strictly less than its radial dimension in the free state, i.e. in the non-mounted state, for example, when the elastically deformable member is resting on a surface and not being compressed in any manner.

The “circumferential direction” is understood to mean the direction that is perpendicular both to the axial direction and to a radius of the bearing device, in other words tangential to a circle centered on the axis of the bearing device. The “axial direction” is understood to mean the direction parallel to the axis of the bearing device. The “radial direction” is understood to mean the direction along a radius of the bearing device, i.e. any direction which intersects the axis of the bearing device and is perpendicular to that axis.

In one embodiment, the elastically deformable member is at least partially made of an elastically deformable material. Preferably, the elastically deformable member is entirely made of an elastically deformable material. As an alternative, it is possible to make the elastically deformable member partially from an elastically deformable material and partially from a rigid material.

Advantageously, the elastically deformable member is at least partially made of an electrically insulating material. Preferably, the elastically deformable member is entirely made of an electrically insulating material. As an alternative, the elastically deformable member may be made partially of an electrically conductive material and partially of an electrically insulating material if the electrically conductive material is surrounded by the electrically insulating material in its one or more zones of contact with the second ring of the bearing and/or the bushing. The elastically deformable member is preferably made of a synthetic material or of an elastomeric material.

According to a first design, the member may be radially in contact both with the surface of the second ring and with the surface of the bushing. In other words, the member is positioned radially between the surface of the second ring and the surface of the bushing. According to a second design, the elastically deformable member may be radially in contact with the surface of the second ring and with the insulating insert. According to a third design, the elastically deformable member may be radially in contact with the insulating insert and with the surface of the second ring.

Advantageously, the elastically deformable member is entirely accommodated between the second ring, the bushing and the insulating insert. In other words, the elastically deformable member is not accessible from outside the device. This means that the elastically deformable member is not subject to impacts.

In one embodiment, the surface of the second ring is provided with at least one circumferential groove in which the elastically deformable member is partially accommodated. The elastically deformable member may radially bear against the bottom of this groove.

As an alternative or in combination, the surface of the bushing is provided with at least one circumferential groove in which the elastically deformable member is partially accommodated. The elastically deformable member may radially bear against the bottom of this groove.

If the insulating insert is made of a synthetic or elastomeric material, the device will be relatively insensitive to temperature variations. In a particular embodiment, the bushing is made of a metal material. The bushing can thus be easily machined to a predetermined radial tolerance.

According to a first design, the bushing delimits the outer surface of the device. In this case, the second ring is the outer ring of the bearing. According to an alternative second design, the bushing delimits the inner surface of the device. In this case, the second ring is the inner ring of the bearing.

In a particular embodiment, the bearing comprises at least one row of rolling elements disposed between raceways of the first and second rings. The rolling elements can be made of a metal material.

The disclosure also relates to an electric motor comprising a housing, a shaft and at least one bearing device as defined above and mounted radially between the housing and the shaft.

### BRIEF DESCRIPTION OF THE DRAWINGS

The present disclosure will be better understood on studying the detailed description of embodiments, given by way of non-limiting example and illustrated by the appended drawings, in which:

FIG. 1 is an axial sectional view of part of a bearing device according to one exemplary embodiment of the present disclosure.

FIG. 2 is a sectional view of a bushing and an elastic deformable member of the bearing device of FIG. 1.

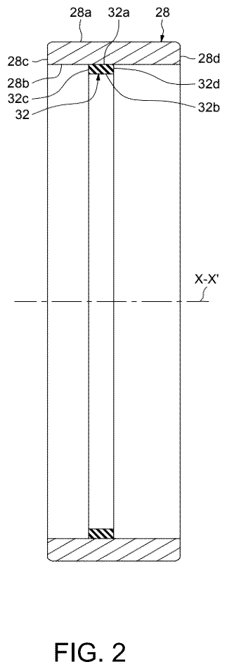

FIG. 3 is a sectional view of a bushing and an elastic deformable member according to another embodiment of the disclosure.

### DETAILED DESCRIPTION

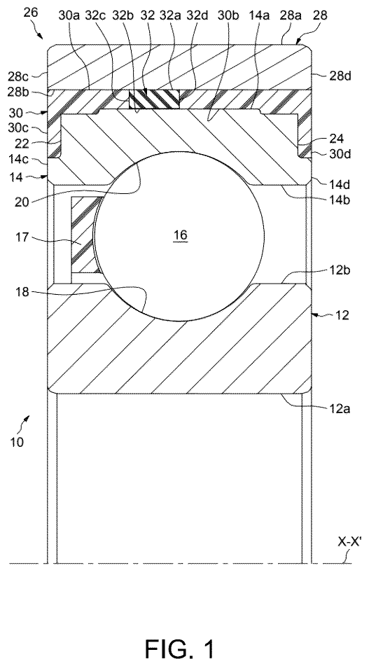

The bearing device illustrated in FIG. 1 comprises a bearing 10 having a first ring 12 and a second ring 14 that are configured to rotate relative to one another about the axis X-X′ of the bearing. In the illustrated embodiment, the first ring 12 is the inner ring of the bearing and the second ring 14 is the outer ring. The inner ring 12 and outer ring 14 of the bearing are concentric and extend axially along the axis X-X′ of the bearing. The inner ring 12 and outer ring 14 are made of steel. The rings are of the solid type. The bearing device is configured such that it does not conduct electric currents. The bearing device has integrated electrical insulation.

In the illustrated exemplary embodiment, the bearing 10 also comprises a row of rolling elements 16, in this case balls, positioned radially between the inner ring 12 and outer ring 14. The rolling elements 16 are made of steel. The bearing 10 also comprises a cage 17 for maintaining an even circumferential spacing of the rolling elements 16. The bearing 10 can also be equipped with seals or sealing flanges (not illustrated).

The inner ring 12 has a cylindrical bore 12a, a cylindrical axially extending radially outer surface 12b radially opposite the bore, and two opposite radially extending end faces (not referenced) axially delimiting the bore and the outer surface. The bore 12a and the outer surface 12b delimit the radial thickness of the inner ring 12. The bore 12a forms the inner surface of the inner ring. The inner ring 12 also has an inner raceway 18 for the rolling elements 16 that is formed on the outer surface 12b. The raceway 18 is directed radially outwards.

The outer ring 14 has a cylindrical axially extending radially outer surface 14a, a cylindrical bore 14b radially opposite the outer surface 14a, and two opposite radially extending end faces 14c, 14d axially delimiting the bore. The outer surface 14a and the bore 14b delimit the radial thickness of the outer ring 14. The bore 14b forms the inner surface of the outer ring. The outer ring 14 further comprises an outer raceway 20 for the rolling elements 16, which is formed on the bore 14b. The raceway 20 is directed radially inwards. In the illustrated embodiment, the outer surface 14a of the ring has two distinct diameters. Alternatively, the outer surface 14a could have a single diameter.

In the illustrated embodiment, a groove 22 is provided on the end face 14c of the outer ring. The groove 22 is axially oriented and open towards the outside of the outer ring. The groove 22 has a bottom that is axially offset towards the inside of the ring relative to the end face 14c. The bottom of the groove 22 forms a shoulder. The bottom of the groove 22 in this case extends radially for ease of manufacturing. The groove 22 is annular in this case.

Similarly, a groove 24 is provided on the end face 14d of the outer ring. The groove 24 is axially oriented and open towards the outside of the outer ring. The groove 24 has a bottom that is axially offset towards the inside of the ring relative to the end face 14d. The bottom of the groove 24 forms a shoulder. The bottom of the groove 24 extends radially in this case. The groove 24 is annular in this case. The grooves 22, 24 are symmetrical with each other relative to a radial midplane of the outer ring. The grooves 22, 24 axially delimit the outer surface 14a. As an alternative, it would be possible for the outer ring 14 not to have the grooves 22, 24.

The bearing device also comprises an electrically insulating sleeve 26 mounted on the outer ring 14. The insulating sleeve 26 is mounted on the outer surface 14a of the outer ring 14. The insulating sleeve 26 is rigidly connected to the outer ring 14. The insulating sleeve 26 comprises a bushing 28 and an insulating insert 30 positioned radially between the outer ring 14 and the bushing 28. The insulating insert 30 is overmolded on the outer ring 14 and on the bushing 28.

As will be described in more detail below, the bearing device also comprises an elastically deformable member 32 which is at least partially embedded inside the insulating insert 30 and in this case positioned radially between the bushing 28 and the outer ring 14. The elastic member 32 is a separate component from the insulating insert 30.

The bushing 28 is annular. The bushing 28 extends axially. The bushing 28 is made in this case in one piece. Alternatively, the bushing 28 could be made in multiple parts bearing against one another, for example, two identical parts. The bushing 28 comprises a cylindrical annular axially extending radially outer surface 28a, and an annular bore 28b which is radially opposite the outer surface 28a. The bore 28b forms the radial inner surface of the bushing 28. The bore 28b is oriented radially inwards, i.e., towards the outer ring 14.

The bushing 28 also comprises two opposite radially extending end faces 28c, 28d axially delimiting the bore and the outer surface. The end faces 28c, 28d delimit the axial length of the bushing. The outer surface 28a and the bore 28b delimit the radial thickness of the bushing 28. The outer surface 28a of the bushing delimits the outer surface of the bearing device 10. In other words, the outer surface 28a defines the outside diameter of the bearing device 10.

In the exemplary embodiment illustrated, the end faces 28c, 28d of the bushing are respectively coplanar with the end faces 14c, 14d of the outer ring. Alternatively, other arrangements can be provided. For example, the bushing 28 could have a smaller or greater axial dimension and could remain axially set back from the faces 14c, 14d of the outer ring, or could project from the faces.

The insulating insert 30 is made of an electrically insulating material. The insulating insert 30 can be made, for example, of a synthetic material, such as a PEEK or a PA46, or it can be made of an elastomeric material, such as rubber. The insulating insert 30 is positioned radially between the outer surface 14a of the outer ring and the bore 28b of the bushing. The insulating insert 30 covers the outer surface 14a of the outer ring except in the area of the elastic element 32. The insulating insert 30 also covers the grooves 22, 24 of the outer ring. The insulating insert 30 also covers the bore 28b of the bushing except in the area of the elastic element 32.

The insulating insert 30 is produced in this case in two axially spaced-apart parts separated by the elastic member 32. The insulating insert 30 comprises a non-continuous cylindrical axial outer surface 30a and a non-continuous cylindrical bore 30b which is radially opposite the outer surface 30a. The outer surface 30a and the bore 30b are non-continuous in the axial direction given the elastic member 32 axially positioned in between. This could also be described as the insulating insert 30 being formed of two axially spaced sub-parts.

The insulating insert 30 also comprises two axially opposite radially extending end faces 30c, 30d axially delimiting the bore and the outer surface. The radially extending end faces 30c, 30d delimit the axial length of the insulating insert 30. The outer surface 30a is in radial contact with the bore 28b of the bushing. The bore 30b is in radial contact with the outer surface 14a of the outer ring and with the grooves 22, 24. The bore 30b has a tiered shape.

In the exemplary embodiment illustrated, the faces 14c, 30c, and 28c are coplanar and the faces 14d, 30d and 28d are coplanar.

Alternatively, other arrangements can be provided. For example, the insulating insert 30 could have a reduced axial dimension and remain axially set back from the faces 14c, 14d of the outer ring. Alternatively, the insulating insert 30 could have a greater axial dimension and axially project from the faces 14c, 14d of the outer ring. In this case, the insulating insert 30 can at least partly cover these faces 14c, 14d. As a variant, the insulating insert 30 could at least partly cover the faces 28c, 28d of the bushing.

In another alternative, or in combination, the bushing 28 could axially project from the insulating insert 30 relative to the faces 30c and 30d, or could remain axially set back from these faces.

As indicated above, the bearing device comprises the elastic member 32 positioned radially between the bushing 28 and the outer ring 14. The elastic member 32 is positioned radially between the outer surface 14a of the outer ring and the bore 28b of the bushing. This means that the elastic member 32 is in contact both with the outer surface 14a of the outer ring and with the bore 28b of the bushing.

The parts of the elastic member 32 which are not in contact with the outer surface 14a of the outer ring and the bore 28b of the bushing are covered by the insulating insert 30. The elastic member 32 is partially covered by the insulating insert 30.

The elastic member 32 is compressed in the radial direction between the outer surface 14a of the outer ring and the bore 28b of the bushing. In other words, in its mounted position, the radial dimension of the elastic member 32 is strictly less than its radial dimension in the free state, that is, when it is not mounted in the bushing 28.

The elastic member 32 is made from an elastically deformable material. By way of example, the elastic member 32 may for example be made from a synthetic material such as Styrene-Ethylene-Butylene-Styrene (SEBS), or an elastomeric material such as silicone rubber, latex, butyl, ethylene propylene diene monomer rubber (EPDM), nitrile, a thermoplastic elastomer, etc. The elastically deformable material of the elastic member 32 is also electrically insulating.

In the exemplary embodiment illustrated, the elastic member 32 has a rectangular profile in cross section. As an alternative, it is possible to provide other polygonal profiles, for example a triangular, square or hexagonal profile, or a circular, oval, elliptical or lobed profile, etc.

In the exemplary embodiment illustrated, the elastic member 32 comprises a cylindrical axial outer surface 32a, a cylindrical bore 32b radially opposite the outer surface 32a, and two opposite radially extending end faces 32c, 32d axially delimiting the bore. The outer surface 32a and the bore 32b delimit the radial dimension of the elastic member 32.

The outer surface 32a and the bore 32b of the elastic member respectively radially bear against the bore 28b of the bushing and against the outer surface 14a of the outer ring. The end faces 32c, 32d are covered by the insulating insert 30.

The bearing device is manufactured as follows.

In a first step, the bearing 10, the bushing 28 and the elastic member 32 are mounted inside a mold, which is provided for the overmolding of the insulating insert 30. In this position mounted inside the mold, the bushing 28 is at a radial distance from the outer ring 14 of the bearing and the elastic member 32 is radially in contact with the outer ring 14 and with the bushing 28.

Then, in a subsequent second step, the insulating insert 30 is overmolded both on the outer ring 14 of the bearing, on the bushing 28 and on the faces 32c, 32d of the elastic member. As an alternative, the insulating insert 30 could be overmolded in two phases: a first phase during which the mold bears against the face 32c of the elastic member and the overmolding is performed on the face 32d, and then a second phase with the bearing 10 being turned around. The mold this time bears against the faces 28d, 30d, 14d of the bushing, of the insert and of the outer ring, and the overmolding is performed against the face 32c of the elastic member.

Finally, the bearing device, which is in the form of a unitary assembly, is removed from the mold.

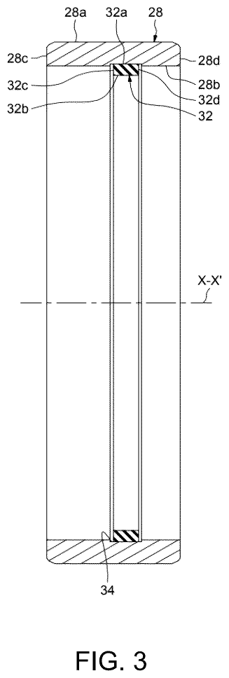

The exemplary embodiment illustrated in FIG. 3, in which identical elements have the same references numerals, differs from the first example in that the bore 28b of the bushing is provided with a groove 34 which extends circumferentially around the axis X-X′ of the bushing. The groove 34 is annular. The elastic member 32 is partially accommodated inside the groove 34 and protrudes radially inwards. The outer surface 32a of the elastic member radially bears against the bottom of the groove 34 of the bore 28b of the bushing. The end faces 32c, 32d of the elastic member remain axially at a distance from the flanks of the groove 34. This allows the elastic member to expand in the axial direction as it is radially compressed between the bushing 28 and the outer ring of the bearing.

In the exemplary embodiments illustrated, the elastic member 32 has an annular shape. In a variant, the elastic member 32 could be in the form of a ring which is open at one point on its circumference. As an alternative, the elastic member 32 could have other shapes, for example a rectangular parallelepiped, and extend over a reduced angular sector, for example less than 15°. In this case, it is preferable to provide at least two, preferably diametrically opposite elastic members 32 radially between the outer ring 14 and the bushing 28.

As indicated above, in the exemplary embodiments illustrated, the insulating insert 30 is produced in two axially spaced-apart parts separated by the elastic member 32. This is due to the annular shape of the elastic member 32. When the elastic member 32 is not annular, the insulating insert 30 is produced in a single part. That is, if there are gaps in the elastic member 32, the two axially spaced-apart parts will be connected by a bridge extending therebetween through the gap.

In the exemplary embodiments illustrated, the elastic member 32 is radially between the outer ring 14 and the bushing 28 by additionally being positioned between them.

As an alternative, before the insulating insert 30 is overmolded, it could be possible to provide a radial clearance between the elastic member 32 and the outer surface 14a of the outer ring, or between the elastic member 32 and the bore 28b of the bushing. In this case, during the overmolding of the insulating insert 30, a small thickness of material fills this radial space.

In this case, the elastic member 32 is positioned radially between the insulating insert 30 and the bore 28b of the bushing, or between the insulating insert 30 and the outer surface 14a of the outer ring. In these two cases, the elastic member 32 is also radially between the outer ring 14 and the bushing 28.

In the exemplary embodiments illustrated, the elastic member 32 is axially offset with respect to the radial midplane of the device passing through the center of the rolling elements. In a variant, the elastic member 32 could be centered with respect to this radial midplane, or be in another offset position with respect to this plane. It is also possible to provide that the elastic member 32 lies flush on one side with the end faces of the inner ring 12 and outer ring 14.

In the exemplary embodiments illustrated, the first ring 12 of the bearing is the inner ring and the second ring 14, on which the insulating insert 30 is overmolded, is the outer ring.

As an alternative, it is possible to provide a reverse arrangement, in which the second ring 14, on which the insulating insert 30 is overmolded, is the inner ring. In this case, the insulating sleeve is disposed in the bore 12a of the inner ring. The insulating insert is then positioned radially between the bore 12a of the inner ring and the outer surface of the bushing. The insulating insert is overmolded at least on the inner surface of the inner ring and at least on the outer surface of the bushing. The elastic member is radially between the inner ring and the bushing. The bore of the bushing delimits the bore of the bearing device.

In the described embodiments, the bearing of the device is provided with a single row of rolling elements. In a variant, the bearing can be provided with several rows of rolling elements. In addition, the rolling bearing can include types of rolling elements other than balls, for example rollers. In another variant, the bearing can be a plain bearing devoid of rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulating bearing devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

1. A bearing device comprising:
a bearing including a first ring and a second ring configured to rotate relative to each other, the second ring having a first cylindrical surface and a second cylindrical surface radially spaced from the first cylindrical surface,
a bushing having an axial length and a first cylindrical surface and a second cylindrical surface radially spaced from the first cylindrical surface of the bushing, an elastically deformable member located radially between the second ring and the bushing, and
an electrically insulating insert overmolded between and connecting the first cylindrical surface of the bushing and the second cylindrical surface of the second ring and contacting the elastically deformable member,
wherein the elastically deformable member radially contacts the second ring and/or the bushing and is radially compressed relative to a free state of the elastically deformable member.

2. The device according to claim 1,
wherein the elastically deformable member is at least partially made of an elastically deformable material.

3. The device according to claim 1,
wherein the elastically deformable member is at least partially made of an electrically insulating material.

4. The device according to claim 1,
wherein the elastically deformable member contacts the second ring and the bushing.

5. The device according to claim 4,
wherein the elastically deformable member is entirely enclosed by the second ring, the bushing and the insulating insert.

6. The device according to claim 1,
wherein the elastically deformable member is annular.

7. The device according to claim 1,
wherein the surface of the second ring or the surface of the bushing includes a circumferential groove, and
wherein at least a portion of the elastically deformable member is located in the circumferential groove.

8. The device according to claim 7,
wherein the elastically deformable member bears radially against a bottom of the groove.

9. The device according to claim 1,
wherein the elastically deformable member comprises an elastomeric material.

10. The bearing device according to claim 1,
wherein the elastically deformable member comprises an electrically insulating annular band of elastomeric material compressed between the second ring and the bushing and spaced axially inward from a first axial end of the bushing and axially inward from a second axial end of the bushing.

11. The bearing device according to claim 10,
wherein the bushing includes a circumferential groove open toward the second ring, and
wherein a first portion of the annular band of material is mounted in the groove and a second portion of the annular band projects out of the groove.

12. The bearing device according to claim 1,
wherein an axial width of the first portion of the annular band of material is less than an axial width of the groove.

13. The bearing device according to claim 10,
wherein the elastically deformable member comprises a continuous strip of material separating a first portion of the electrically insulating insert from a second portion of the electrically insulating insert such that no part of the first portion of the electrically insulating insert contacts the second portion of the electrically insulating insert.

14. The bearing device according to claim 10,
wherein the elastically deformable member comprises a strip of material having at least one gap, and
wherein a first portion of the electrically insulating insert on a first axial side of the elastically deformable member is connected to a second portion of the electrically insulating insert on a second axial side of the elastically deformable member by a connecting portion of the electrically insulating insert in the at least one gap.

15. An electric motor comprising:
a housing,
a shaft, and
at least one bearing device according to claim 1 mounted radially between the housing and the shaft.
